(19) United States
(12) Patent Application Publication
(10) Pub. No.: US 2025/0367553 A1
(43) Pub. Date: Dec. 4, 2025

(54) VIRTUAL ENVIRONMENT–BASED INTERACTION METHOD AND APPARATUS, DEVICE, AND MEDIUM

(71) Applicant: Tencent Technology (Shenzhen) Company Limited, Shenzhen (CN)

(72) Inventor: Jie XIAO, Shenzhen (CN)

(21) Appl. No.: 19/299,167

(22) Filed: Aug. 13, 2025

Related U.S. Application Data
(63) Continuation of application No. PCT/CN2024/098270, filed on Jun. 7, 2024.

(30) Foreign Application Priority Data
Aug. 4, 2023 (CN) 202310984306.4

(51) Int. Cl. A63F 13/52

(52) U.S. Cl. CPC A63F 13/52

(57) ABSTRACT

A virtual environment-based interaction method is performed by a computer device. The method includes: displaying at least one killed individual located in a virtual environment; in response to a resurrection skill selection operation, displaying character information of a first virtual character corresponding to a first killed individual, the first killed individual being a killed individual selected through the resurrection skill selection operation from the at least one killed individual; and switching display from the first killed individual to the resurrected first virtual character in response to a resurrection skill casting operation. The foregoing method, apparatus, device, and medium can improve efficiency of human-computer interaction and reduce resource consumption caused by mode switching.

### CROSS-REFERENCE TO RELATED APPLICATIONS

This application is a continuation application of PCT Patent Application No. PCT/CN2024/098270, entitled “VIRTUAL CHARACTER PROCESSING METHOD AND APPARATUS, ELECTRONIC DEVICE, COMPUTER-READABLE STORAGE MEDIUM, AND COMPUTER PROGRAM PRODUCT” filed on Jun. 7, 2024, which claims priority to Chinese Patent Application No. 202310984306.4, entitled “VIRTUAL ENVIRONMENT-BASED INTERACTION METHOD AND APPARATUS, DEVICE, AND MEDIUM” filed on Aug. 4, 2023, both of which are incorporated herein by reference in their entirety.

### FIELD OF THE TECHNOLOGY

This application relates to the field of human-computer interaction, and in particular, to a virtual environment-based interaction method and apparatus, a device, and a medium.

### BACKGROUND OF THE DISCLOSURE

In an application (for example, a first-person shooting game (FPS)) supporting a virtual environment, after a player is killed and turned into a box, the player loses an identity model feature of the player. That a player is killed and turned into a box means that the player becomes a box after being killed. When some players having a resurrection skill cast the resurrection skill, the players need to first accurately recognize a teammate player and then cast the resurrection skill.

In a related art, these players having the resurrection skill need to first enable a scanning mode, where detailed information about a targeted virtual item is displayed above the virtual item. Then, the players recognize, based on the detailed information, whether the virtual item is the teammate player. Finally, the players cast the resurrection skill to resurrect the teammate player.

### SUMMARY

This application provides a virtual environment-based interaction method and apparatus, a device, and a medium. The technical solutions are as follows.

According to an aspect of this application, a virtual environment-based interaction method is performed by a computer device and the method includes:
displaying at least one killed individual located in a virtual environment;
in response to a resurrection skill selection operation, displaying character information of a first virtual character corresponding to a first killed individual, the first killed individual being a killed individual selected through the resurrection skill selection operation from the at least one killed individual; and
switching display from the first killed individual to the resurrected first virtual character in response to a resurrection skill casting operation.

According to another aspect of this application, a computer device is provided. The computer device includes: a processor and a memory. The memory has a computer program stored therein, and the computer program, when loaded and executed by the processor, causes the computer device to implement the foregoing virtual environment-based interaction method.

According to another aspect of this application, a non-transitory computer-readable storage medium is provided, having a computer program stored thereon. The computer program, when loaded and executed by a processor of a computer device, causes the computer device to implement the foregoing virtual environment-based interaction method.

A computer device displays at least one killed individual located in a virtual environment, a similarity between display forms of different killed individuals exceeding a threshold; displays, in response to a resurrection skill selection operation, character information of a first virtual character corresponding to a first killed individual, the first killed individual being a killed individual selected through the resurrection skill selection operation from the at least one killed individual, and the first killed individual being a display element corresponding to the first virtual character after being killed; and switches display from the first killed individual to the resurrected first virtual character in response to a resurrection skill casting operation. Based on this, without a need of switching to a scanning mode, a to-be-resurrected killed individual is directly selected through the resurrection skill selection operation and character information of a virtual character corresponding to the to-be-resurrected killed individual is displayed, so that a player quickly and accurately recognizes and selects, based on the character information, the to-be-resurrected killed individual from a plurality of killed individuals having a same display form or similar display forms, and resurrects, by using a resurrection skill, the virtual character corresponding to the to-be-resurrected killed individual. An operation is simple, and efficiency of human-computer interaction can be improved. In addition, in this interaction method, the virtual character can be resurrected only by performing, in a current mode, an operation related to the resurrection skill, without a need of switching from the current mode to the scanning mode and from the scanning mode back to the current mode. This helps reduce resource consumption caused by mode switching.

### BRIEF DESCRIPTION OF THE DRAWINGS

FIG. 1 is a block diagram of a structure of a computer system according to an exemplary embodiment.

FIG. 2 is a schematic diagram of a virtual environment-based interaction method according to an exemplary embodiment.

FIG. 3 is a flowchart of a virtual environment-based interaction method according to an exemplary embodiment.

FIG. 4 is a flowchart of a virtual environment-based interaction method according to an exemplary embodiment.

FIG. 5 is a flowchart of a virtual environment-based interaction method according to an exemplary embodiment.

FIG. 6 is a flowchart of a virtual environment-based interaction method according to an exemplary embodiment.

FIG. 7 is a diagram of an interface of a virtual environment-based interaction method according to an exemplary embodiment.

FIG. 8 is a diagram of an interface of a virtual environment-based interaction method according to an exemplary embodiment.

FIG. 9 is a diagram of an interface of a virtual environment-based interaction method according to an exemplary embodiment.

FIG. 10 is a diagram of an interface of a virtual environment-based interaction method according to an exemplary embodiment.

FIG. 11 is a diagram of an interface of a virtual environment-based interaction method according to an exemplary embodiment.

FIG. 12 is a schematic diagram of a virtual environment-based interaction method according to an exemplary embodiment.

FIG. 13 is a block diagram of a structure of a virtual environment-based interaction apparatus according to an exemplary embodiment.

FIG. 14 is a block diagram of a structure of a computer device according to an exemplary embodiment.

### DESCRIPTION OF EMBODIMENTS

To make the objectives, technical solutions, and advantages of this application clearer, the following further describes implementations of this application in detail with reference to the accompanying drawings.

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The following implementations described in the following exemplary embodiments do not represent all implementations that are consistent with this application. On the contrary, the implementations are merely examples of the apparatus and methods that are described in detail in the appended claims and that are consistent with some aspects of this application.

The terms used in this application are for the purpose of describing specific embodiments only and are not intended to limit this application. The singular forms of “a” and “the” used in this application and the appended claims are also intended to include the plural forms as well, unless the context clearly indicates otherwise. The term “and/or” used herein indicates and includes any or all possible combinations of one or more associated listed items.

In this application, a prompt interface and a pop-up window may be displayed or voice prompt information may be outputted before and during related data (for example, a resurrection skill casting operation and a resurrection skill selection operation) of a user is collected. The prompt interface, the pop-up window, or the voice prompt information are configuring for prompting the user that related data is collected currently. In this way, in this application, only after a confirmation operation performed by the user on the prompt interface or the pop-up window is acquired, a related operation of acquiring the related data of the user starts, or otherwise (that is, when the confirmation operation performed by the user on the prompt interface or the pop-up window is not acquired), the related operation of the related data of the user ends, that is, the related data of the user is not acquired. In other words, in this application, all the collected user data is collected with user consent and authorization, and collection, use, and processing of the related user data need to comply with relevant laws, regulations, and standards of relevant countries and regions.

Although the terms first, second, and the like may be used in this application to describe various information, the information is not limited to the terms. These terms are merely used to distinguish between information of the same type. For example, within the scope of this application, a first parameter may also be referred to as a second parameter, and similarly, the second parameter may also be referred to as the first parameter. Depending on the context, for example, the term “if” used herein may be interpreted as “while” or “when,” or “in response to determination.”

A brief introduction to terms involved in embodiments of this application is given below.

Virtual environment: It is a virtual environment displayed or provided when a client is run on a terminal. The virtual environment may be a simulated world of the real world, a semi-simulated and semi-fictional three-dimensional world, or a completely fictional three-dimensional world. The virtual environment may be any one of a two-dimensional virtual environment, a two-and-a-half-dimensional virtual environment, and a three-dimensional virtual environment. In one embodiment, the virtual environment is further configured for allowing for a virtual environment battle between at least two virtual characters, and there are virtual resources available for use by the at least two virtual characters in the virtual environment. In one embodiment, the virtual environment includes a lower left area and an upper right area that are symmetrical, and virtual characters belonging to two hostile camps respectively occupy one of the areas.

Virtual character: It is a movable object in a virtual environment. The movable object may be at least one of a virtual person, a virtual animal, a cartoon person, and a virtual pet (also referred to as a virtual pet character). In one embodiment, when the virtual environment is a three-dimensional virtual environment, the virtual character may be a three-dimensional virtual model. Each virtual character has a shape and a volume in the three-dimensional virtual environment, and occupies some space in the three-dimensional virtual environment. In one embodiment, the virtual character is a three-dimensional character based on a three-dimensional human skeleton technology. The virtual character achieves different external images by wearing different skins. In some implementations, the virtual character may alternatively be implemented by using a two-and-a-half-dimensional model or a two-dimensional model, which is not limited in embodiments of this application.

Resurrection skill: It is a virtual skill, and can restore a specific amount of health points to a killed teammate, to enable the teammate to regain a capability of participate in combat.

In response to: It is configured for representing a condition or a status on which an executed operation depends. When the dependent condition or status is satisfied, the executed one or more operations may be real-time or have a set delay. There is no limit to a sequence on the plurality of executed operations unless otherwise specified.

In a related art, players having a resurrection skill need to first enable a scanning mode, where detailed information about a targeted virtual item is displayed above the virtual item. Then, the players recognize, based on the detailed information, whether the virtual item is a teammate player. After determining that the virtual item is the teammate player, the players cast the resurrection skill to resurrect the teammate player. A method in the related art is complex to operate, and efficiency of human-computer interaction is low. Therefore, how to provide a virtual environment-based interaction method that can improve the efficiency of the human-computer interaction is a problem that needs to be resolved urgently.

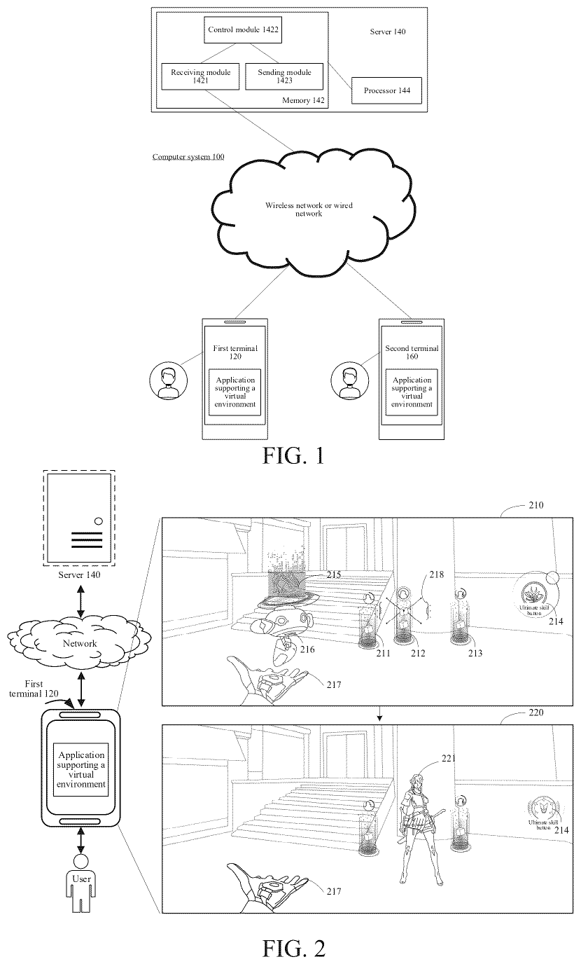

FIG. 1 is a block diagram of a structure of a computer system according to an exemplary embodiment of this application. The computer system may be implemented as a system architecture of a virtual environment-based interaction method. The computer system 100 includes a first terminal 120, a server 140, and a second terminal 160.

The first terminal 120 may be an electronic device like a mobile phone, a tablet computer, an on board terminal (in-vehicle terminal), a wearable device, a personal computer (PC), and an unmanned reservation terminal. An application supporting a virtual environment is installed and run on the first terminal 120. For example, the application may be any one of a battle royale shooting game, a virtual reality (VR) application, an augmented reality (AR) program, a three-dimensional map program, a virtual reality game, an augmented reality game, a first-person shooting game (FPS), a third-person shooting game (TPS), a multiplayer online battle arena (MOBA) game, and a simulation game (SLG).

The first terminal 120 is a terminal used by a first user. The first user uses the first terminal 120 to control a first virtual character located in the virtual environment. The controlling includes but is not limited to at least one of adjusting a body posture, crawling, walking, running, riding, jumping, driving, picking up, shooting, attacking, throwing, and building a virtual architecture. The first user may further use the first terminal 120 to use a resurrection skill in the virtual environment to resurrect another killed teammate virtual character.

The second terminal 160 may be an electronic device like a mobile phone, a tablet computer, an on board terminal (in-vehicle terminal), a wearable device, a personal computer (PC), and an unmanned reservation terminal. An application supporting a virtual environment is installed and run on the second terminal 160. For example, the application may be any one of a battle royale shooting game, a virtual reality (VR) application, an augmented reality (AR) program, a three-dimensional map program, a virtual reality game, an augmented reality game, a first-person shooting game (FPS), a third-person shooting game (TPS), a multiplayer online battle arena (MOBA) game, and a simulation game (SLG).

The second terminal 160 is a terminal used by a second user. The second user uses the second terminal 160 to control a second virtual character located in the virtual environment. The controlling includes but is not limited to at least one of adjusting a body posture, crawling, walking, running, riding, jumping, driving, picking up, shooting, attacking, throwing, and building a virtual architecture. The second user may further use the second terminal 160 to use a resurrection skill in the virtual environment to resurrect another killed teammate virtual character.

The first terminal 120, the second terminal 160, and the server 140 may communicate with each other over a network, for example, a wired or wireless network.

The server 140 may be an independent physical server, or may be a server cluster including a plurality of physical servers or a distributed system, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server 140 includes at least one of a server, a plurality of servers, a cloud computing platform, and a virtualization center. For example, the server 140 includes a processor 144 and a memory 142. The memory 142 further includes a receiving module 1421, a control module 1422, and a sending module 1423. The receiving module 1421 is configured to receive a request sent by a client, for example, a viewing request to view at least one of a quantity, positions, and attribute values of enemy virtual characters. The control module 1422 is configured to control rendering of a virtual environment picture. The sending module 1423 is configured to send a response to the client, for example, send at least one of the quantity, the positions, and the attribute values of the enemy virtual characters to the client. The server 140 is configured to provide a background service for the applications on the first terminal 120 and the second terminal 160.

In one embodiment, the server 140 undertakes primary computing work, and the first terminal 120 and the second terminal 160 undertake secondary computing work. Alternatively, the server 140 undertakes secondary computing work, and the first terminal 120 and the second terminal 160 undertake primary computing work. Alternatively, the server 140, the first terminal 120, and the second terminal 160 perform collaborative computing by using a distributed computing architecture among each other. In one embodiment, the applications installed on the first terminal 120 and the second terminal 160 are the same, or the applications installed on the two terminals are the same type of applications of different control system platforms. In embodiments of this application, a form of the application installed on the first terminal 120 and the application installed on the second terminal 160 is not limited, including but not limited to the application (App) and an applet installed on the first terminal 120 and the second terminal 160, and may alternatively be a form of a website. The first terminal 120 may generally be one of a plurality of terminals, and the second terminal 160 may generally be one of the plurality of terminals. This embodiment only uses the first terminal 120 and the second terminal 160 as examples. Device types of the first terminal 120 and the second terminal 160 may be the same or different. The following embodiment uses an example in which the terminal includes a smartphone for description.

A person skilled in the art may learn that there may be more or fewer first terminals 120 and second terminals 160. For example, there may be only one first terminal 120 and one second terminal 160 (that is, a user battles against artificial intelligence), or there may be eight first terminals 120 and second terminals 160 in total (1v1v1v1v1v1v1v1, where the eight users play in a round-robin with eliminations until a winner emerges), or there may be more first terminals 120 and second terminals 160. Quantities and device types of the first terminals 120 and the second terminals 160 are not limited in embodiments of this application.

An embodiment of this application provides a virtual environment-based interaction method. The method may be performed by a computer device. In one embodiment, the computer device includes the first terminal 120 or the second terminal 160 shown in FIG. 1. Applications supporting a virtual environment are respectively installed and run on the first terminal 120 and the second terminal 160.

For example, FIG. 2 is a schematic diagram of a virtual environment-based interaction method according to an exemplary embodiment of this application. Using an example in which the first terminal 120 performs the method, operations are briefly described as follows.

Operation 1: The first terminal 120 displays at least one killed individual located in a virtual environment, a similarity between display forms of different killed individuals exceeding a threshold.

For example, the similarity between the display forms of different killed individuals exceeding the threshold includes a case in which the display forms of different killed individuals are the same, and a case in which the display forms of different killed individuals are similar but different.

As shown in a user interface 210 in FIG. 2, the first terminal 120 displays, on the user interface 210, an ultimate skill button 214, a killed individual 211, a killed individual 212, a killed individual 213, an information panel 215, a movable carrier 216, a hand 217 of a main control virtual character manipulated by a first user, and a scanning frame 218. The information panel 215 is configured to display character information. The killed individual 211 is a display element corresponding to a virtual character 211 after being killed, the killed individual 212 is a display element corresponding to a virtual character 212 after being killed, and the killed individual 213 is a display element corresponding to a virtual character 213 after being killed. The killed individual 211, the killed individual 212, and the killed individual 213 are displayed in display forms of box-shaped elements having the same size, shape, and color. The movable carrier 216 may be located on the hand 217. In this embodiment, the movable carrier 216, the hand 217 of the main control virtual character manipulated by the first user, and the scanning frame 218 are optional display content on the user interface 210. In some embodiments, the ultimate skill button may also be referred to as a resurrection operation button.

Operation 2: The first terminal 120 displays, in response to a resurrection skill selection operation, character information of a first virtual character corresponding to a first killed individual, the first killed individual being a killed individual selected through the resurrection skill selection operation from the at least one killed individual, and the first killed individual being a display element corresponding to the first virtual character after being killed.

Specifically, an example in which the first killed individual is the killed individual 212 is used. The first user initiates the resurrection skill selection operation by touching and holding the ultimate skill button 214 on the user interface 210 in FIG. 2. Then, the first terminal 120 displays character information of a first virtual character 212 corresponding to the first killed individual 212 selected through the resurrection skill selection operation, and the character information is displayed on the information panel 215. In one embodiment, when the first user initiates the resurrection skill selection operation by touching and holding the ultimate skill button 214 on the user interface 210 in FIG. 2, the first terminal 120 displays the scanning frame 218 on the user interface 210. The scanning frame 218 is configured for selecting the first killed individual 212. At the same time, the first terminal 120 displays the movable carrier 216 located on the hand 217 on the user interface 210, and displays the information panel 215 corresponding to the character information in a peripheral area of the movable carrier 216, for example, one of areas directly above, to the left, or to the right of the movable carrier.

Operation 3: The first terminal 120 switches display from the first killed individual to the resurrected first virtual character in response to a resurrection skill casting operation.

Specifically, an example in which the first killed individual is the killed individual 212 is used. The first user initiates the resurrection skill casting operation by releasing the ultimate skill button 214 on the user interface 220 in FIG. 2, and then the first terminal 120 switches display from the first killed individual 212 to the resurrected first virtual character 212. In one embodiment, the first terminal 120 may cancel display of the movable carrier 216 on the user interface 220.

In conclusion, in the virtual environment-based interaction method provided in this embodiment of this application, when a similarity of a display form of the at least one killed individual displayed in the virtual environment exceeds the threshold, character features of virtual characters corresponding to killed individuals basically disappear, and it is difficult to recognize a to-be-resurrected killed individual. According to the method in this embodiment of this application, without a need of triggering enabling of a scanning mode, the first killed individual can be directly selected through the resurrection skill selection operation and the character information of the first virtual character corresponding to the first killed individual is displayed. The to-be-resurrected killed individual can be quickly recognized based on the character information, and the virtual character corresponding to the to-be-resurrected killed individual is resurrected. An operation is simple, and efficiency of human-computer interaction can be improved. In addition, the virtual character can be resurrected only by performing, in a current mode, an operation related to a resurrection skill, without a need of switching from the current mode to the scanning mode and from the scanning mode back to the current mode. This helps reduce resource consumption caused by mode switching.

Further, in the method in this embodiment of this application, the movable carrier may be further displayed, and the character information of the first virtual character corresponding to the first killed individual may be displayed in the peripheral area of the movable carrier during display of the character information of the first virtual character. Because the movable carrier can interact with a user, this display manner is different from a display manner in which the character information is directly overlaid on an interface element (Head Up Display, HUD) that is on a user interface (UI) plane layer and that is configured for information display, or only a non-movable panel is provided in a virtual scenario for overlaying the character information. In this manner, the character information of the first virtual character can be displayed and move with the movable carrier. This increases interactivity and flexibility of information display, enriches user experience, and improves efficiency of human-computer interaction.

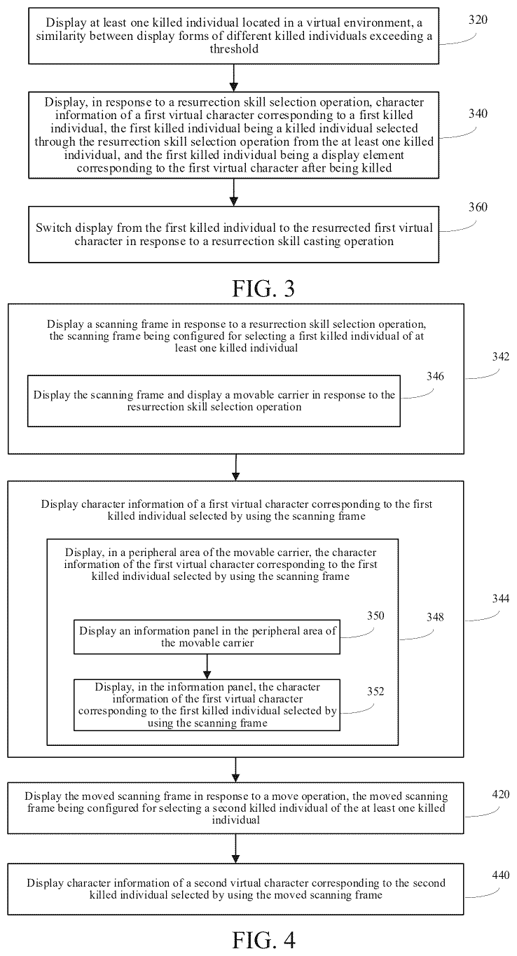

FIG. 3 is a flowchart of a virtual environment-based interaction method according to an exemplary embodiment of this application. An example in which the method is performed by a computer device is used for description. The computer device may be the first terminal 120 and/or the second terminal 160 shown in FIG. 1. The method includes operation 320, operation 340, and operation 360.

Operation 320: Display at least one killed individual located in a virtual environment, a similarity between display forms of different killed individuals exceeding a threshold.

The virtual environment is a virtual environment displayed or provided when a client is run on the computer device.

Being killed is a state in which a virtual character dies after being attacked in a current game match.

In one embodiment, when a current amount of health points of the virtual character is less than a threshold, or when the virtual character receives a preset virtual skill, or when the virtual character receives a virtual skill and an amount of consumed health points corresponding to the virtual skill is greater than a current amount of health points of the virtual character, the computer device determines that virtual character is killed in the current game match.

The killed individual is a display element corresponding to the virtual character in the current game match after being killed.

In one embodiment, the display element corresponding to the virtual character after being killed may be at least one of an image element, an icon element, a text element, a block element, a spherical element, a two-dimensional element, and a three-dimensional element. The killed individual may be represented by using at least one of an image element, an icon element, a text element, a block element, a spherical element, a two-dimensional element, and a three-dimensional element.

In one embodiment, display elements corresponding to different virtual characters after being killed may be the same, different, or partially the same. For example, a display element corresponding to a virtual character 1 after being killed is a spherical element, and a display element corresponding to a virtual character 2 after being killed is a text element. In this case, when the spherical element is displayed on a user interface, another player may learn that the virtual character 1 is killed at this moment, and when the text element is displayed on the user interface, another player may learn that the virtual character 2 is killed at this moment.

In some embodiments, the display element corresponding to the virtual character after being killed may be pre-configured based on an attribute and a type of the virtual character, or for a virtual character owned by a player, the player may customize a display element corresponding to the virtual character after being killed.

The display form is a form used to represent the killed individual in the virtual environment. The display form of the killed individual is a display form of a display element corresponding to the virtual character that is killed and that is of the killed individual.

In one embodiment, the display form includes at least one of a particle form, a form of upward-floating particles, a solid form, a phantom form, and a soul form. For example, using an example in which the display element of the virtual character after being killed is a spherical element, and the display form is a phantom form, after the virtual character is killed, a spherical element is displayed on the user interface in the phantom form, similar to displaying a shadow of the spherical element, and another player may learn that the virtual character is killed.

In some embodiments, the similarity between the display forms of different killed individual exceeds the threshold. The threshold may be set based on experience, or may be flexibly adjusted based on an actual situation, which is not limited in embodiments of this application.

For example, the similarity between the display forms of different killed individuals exceeding the threshold includes a case in which the display forms of different killed individuals are the same, and a case in which the display forms of different killed individuals are similar but different.

In one embodiment, the similarity may be determined by using an image similarity algorithm. For example, based on images corresponding to the display forms of different killed individuals, the similarity between the display forms of different killed individuals is determined by using a Hash algorithm or a scale-invariant feature transform (SIFT) algorithm.

In one embodiment, after virtual characters corresponding to different killed individuals are killed, when different killed individuals are the same in respect of at least one of the display element and the display form, it is determined that the similarity between the display forms of different killed individuals exceeds the threshold. For example, a killed individual 1 corresponds to the virtual character 1, a display element of the virtual character 1 after being killed is a spherical element, and a display form is a phantom form. A killed individual 2 corresponds to the virtual character 2, a display element of the virtual character 2 after being killed is a spherical element, and a display form is a solid form. In this case, it is determined that a similarity between the display forms of the killed individual 1 and the killed individual 2 exceeds the threshold.

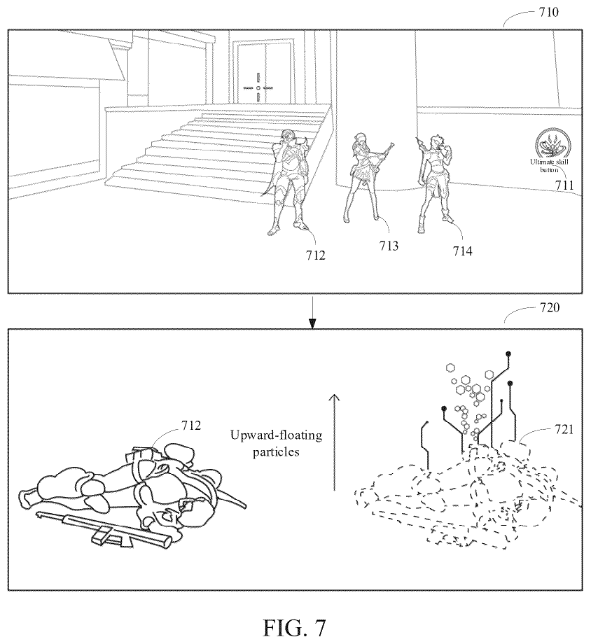

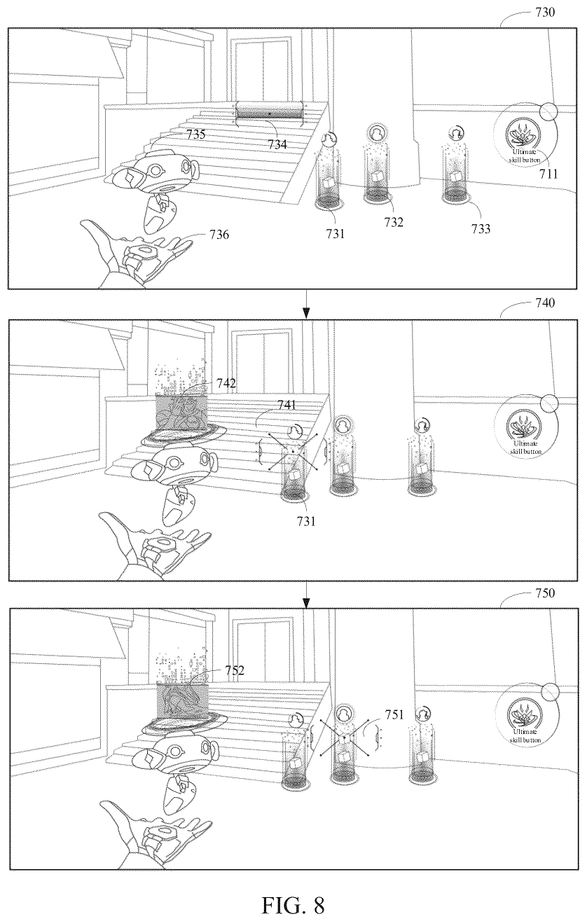

In a possible embodiment, refer to FIG. 7. As shown in a user interface 710 in FIG. 7, three surviving virtual characters are displayed on the user interface 710, which are respectively a virtual character 712, a virtual character 713, and a virtual character 714. A resurrection operation button 711 is further displayed on the user interface 710. Using an example in which the virtual character 712 is killed, as shown in a user interface 720 in FIG. 7, after the virtual character 712 is killed, a killed individual of the virtual character 712 after being killed is displayed in a display form 721 of upward-floating particles. An example in which display elements corresponding to the virtual character 712, the virtual character 713, and the virtual character 714 are all block elements is used. Refer to FIG. 8. As shown in a user interface 730 in FIG. 8, a killed individual 731 of the virtual character 712 after being killed, a killed individual 732 of the virtual character 713 after being killed, and a killed individual 733 of the virtual character 714 after being killed are displayed on the user interface 730, the killed individual 731, the killed individual 732, and the killed individual 733 are displayed in the same display form, and all are displayed as block elements with upward-floating particles.

Operation 340: Display, in response to a resurrection skill selection operation, character information of a first virtual character corresponding to a first killed individual, the first killed individual being a killed individual selected through the resurrection skill selection operation from the at least one killed individual, and the first killed individual being a display element corresponding to the first virtual character after being killed.

The resurrection skill selection operation is an operation of selecting a killed individual of a to-be-resurrected virtual character before a resurrection skill is casted.

In one embodiment, the resurrection skill selection operation is triggered by touching and holding a resurrection operation button. The computer device triggers starting of the resurrection skill selection operation in response to that duration of clicking/tapping the resurrection operation button is greater than a threshold.

In one embodiment, different shortcut keys corresponding to different operations are preset. The resurrection skill selection operation may alternatively be triggered by pressing a shortcut key corresponding to the resurrection skill selection operation. The computer device triggers starting of the resurrection skill selection operation in response to a clicking/tapping operation on the shortcut key corresponding to the resurrection skill selection operation.

The first killed individual is a killed individual selected through the resurrection skill selection operation from the at least one killed individual. There may be one or more killed individuals selected through the resurrection skill selection operation. Each killed individual selected through the resurrection skill selection operation may be used as a first killed individual. In other words, there may be one or more first killed individuals. The first killed individual is the display element corresponding to the first virtual character after being killed. A quantity of first virtual characters is the same as a quantity of first killed individuals, and each first killed individual corresponds to a first virtual character.

In one embodiment, if there is one first killed individual, casting the resurrection skill once can resurrect one virtual character. In some other examples, if there is at least one first killed individual, casting the resurrection skill once can resurrect at least one virtual character.

In one embodiment, the first virtual character corresponding to the first killed individual is a teammate virtual character. The teammate virtual character is another virtual character in the same camp as a main control virtual character currently controlled by a player in a current game match.

In one embodiment, the first virtual character corresponding to the first killed individual is an enemy virtual character. The enemy virtual character is another virtual character in a different camp from the main control virtual character currently controlled by the player in the current game match.

In one embodiment, the resurrection operation button provides a function of selecting a killed individual. For example, during touching and holding on the resurrection operation button, a rotation operation is simultaneously performed in an operation area of the resurrection operation button. In other words, a touching and holding and rotation operation is performed in the operation area of the resurrection operation button, to select different killed individuals. In some other embodiments, when a user triggers initiation of the rotation operation of the resurrection skill, the computer device automatically selects a killed individual as the first killed individual.

The character information is information configured for representing a specific identity of a virtual character. In one embodiment, the character information includes at least one of a character nickname, a character image, a camp to which the character belongs, a character attribute, and a virtual skill owned by the character.

For example, the computer device displays, in response to the resurrection skill selection operation, the character information of the first virtual character corresponding to the first killed individual. The character information may be displayed in a fixed area on the user interface, for example, is displayed in an area that is in a game and that is configured for displaying broadcast information. The character information may alternatively be displayed in a peripheral area of a movable carrier on the user interface. A display manner of the character information is described in detail in subsequent embodiments.

In a possible embodiment, refer to FIG. 8. As shown in a user interface 740 in FIG. 8, the first killed individual is a killed individual 731. The computer device displays, in response to the resurrection skill selection operation, character information 742 of the first virtual character 712 corresponding to the first killed individual 731. The character information 742 may be a character image of the first virtual character 712.

Operation 360: Switch display from the first killed individual to the resurrected first virtual character in response to a resurrection skill casting operation.

The resurrection skill casting operation is an operation of casting the resurrection skill to the to-be-resurrected virtual character.

The resurrected first virtual character is a first virtual character that receives the resurrection skill and is resurrected.

For example, after the display is switched from the first killed individual to the resurrected first virtual character, the character information corresponding to the resurrected first virtual character is displayed on the user interface. In one embodiment, the character information corresponding to the resurrected first virtual character is the same as character information corresponding to the first virtual character before being killed. The character information includes at least one of a character nickname, a character image, a camp to which the character belongs, a character attribute, and a virtual skill owned by the character.

In one embodiment, a character image of the resurrected first virtual character displayed on the user interface is the same as a character image of the first virtual character before being killed, or a character image of the resurrected first virtual character displayed on the user interface is partially the same as a character image of the first virtual character before being killed. For example, a character image of a resurrected virtual character 1 is the same as a character image of the virtual character 1 before being killed, or a halo icon is added above the head of the resurrected virtual character 1. The halo icon is configured for representing that the virtual character 1 in this case is the resurrected virtual character 1. The halo icon may be further configured for distinguishing the resurrected virtual character from the virtual character before being killed.

For example, the computer device switches display from the first killed individual to the resurrected first virtual character in response to the resurrection skill casting operation.

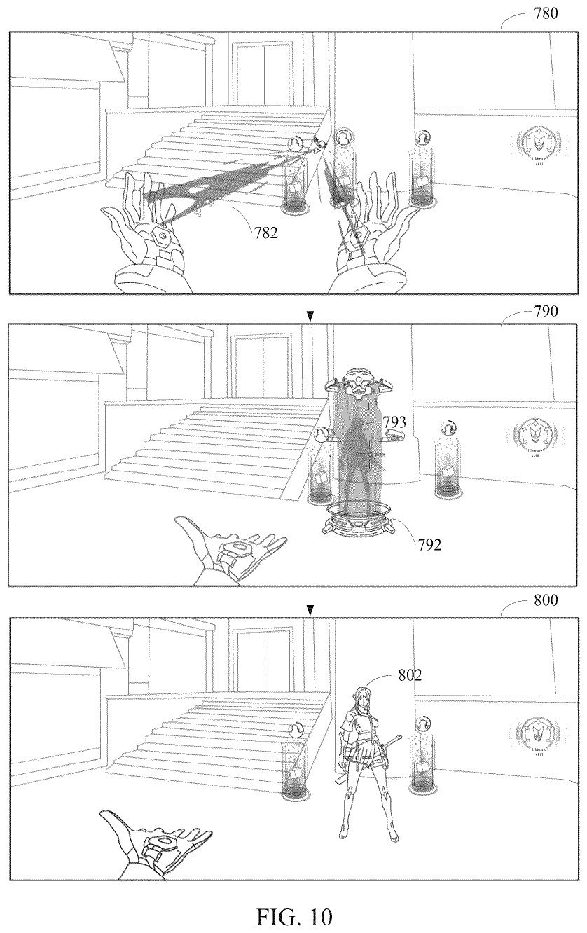

In a possible embodiment, refer to FIG. 10. As shown in a user interface 800 in FIG. 10, the computer device switches display from the first killed individual to a resurrected first virtual character 802 in response to the resurrection skill casting operation, and another non-resurrected killed individual remains unchanged.

In conclusion, according to the virtual environment-based interaction method provided in this embodiment of this application, the computer device displays the at least one killed individual located in the virtual environment, the similarity between the display forms of different killed individuals exceeding the threshold; displays, in response to the resurrection skill selection operation, the character information of the first virtual character corresponding to the first killed individual, the first killed individual being the killed individual selected through the resurrection skill selection operation from the at least one killed individual, and the first killed individual being the display element corresponding to the first virtual character after being killed; and switches display from the first killed individual to the resurrected first virtual character in response to the resurrection skill casting operation. Based on this, without a need of switching to a scanning mode, a to-be-resurrected killed individual is directly selected through the resurrection skill selection operation and character information of a virtual character corresponding to the to-be-resurrected killed individual is displayed, so that a player can accurately select the to-be-resurrected killed individual from a plurality of killed individuals having a same display form or similar display forms, and resurrect, by using the resurrection skill, the virtual character corresponding to the to-be-resurrected killed individual. An operation is simple, and efficiency of human-computer interaction can be improved. In addition, in this interaction method, the virtual character can be resurrected only by performing, in a current mode, an operation related to the resurrection skill, without a need of switching from the current mode to the scanning mode and from the scanning mode back to the current mode. This helps reduce resource consumption caused by mode switching.

FIG. 4 is a flowchart of a virtual environment-based interaction method according to an exemplary embodiment of this application. The following embodiment describes an example of a manner of displaying the character information of the first virtual character corresponding to the first killed individual. In an actual scenario, one of the manners may be selected, or a plurality of manners may be combined.

1. A first display manner of the character information of the first virtual character corresponding to the first killed individual.

In some embodiments, operation 340 may be implemented as operation 342 and operation 344.

Operation 342: Display a scanning frame in response to the resurrection skill selection operation, the scanning frame being configured for selecting the first killed individual of the at least one killed individual.

The scanning frame is a framed area that provides a scanning function and a selection function.

In one embodiment, because the resurrection skill selection operation requires selecting the first killed individual from the at least one killed individual, the computer device displays the scanning frame in response to the resurrection skill selection operation. The scanning frame is configured for selecting the first killed individual of the at least one killed individual.

In one embodiment, the scanning frame is displayed at a central position of the user interface. For example, a central position of the scanning frame may be the same as the central position of the user interface. For example, the central position of the scanning frame may be different from the central position of the user interface. For example, an upper-left corner position of the scanning frame is the same as the central position of the user interface, or a lower-right corner position of the scanning frame is the same as the central position of the user interface.

In some embodiments, the scanning frame may alternatively be displayed at another position on the user interface. For example, the another position may include but is not limited to, a left area, a right area, an upper area, a lower area, and the like of the user interface.

In some other examples, the scanning frame is also referred to as a “crosshair”. In this case, the computer device displays the crosshair in response to the resurrection skill selection operation. The crosshair is configured for selecting the first killed individual of the at least one killed individual.

Operation 344: Display the character information of the first virtual character corresponding to the first killed individual selected by using the scanning frame.

In one embodiment, the computer device displays the character information of the first virtual character corresponding to the first killed individual selected by using the scanning frame. The character information may be displayed at any position on the user interface. For example, the character information is displayed in one of a left area, a right area, an upper area, or a lower area of the user interface. Alternatively, the user interface includes a floating window, and the character information is displayed in the floating window.

In some embodiments, the computer device displays the scanning frame in response to the resurrection skill selection operation, switches a current mode of the scanning frame to a scanning mode, and then switches the current mode of the scanning frame from the scanning mode to a locking mode after the first killed individual of the at least one killed individual is selected through the resurrection skill selection operation. Then, the character information of the first virtual character corresponding to the first killed individual selected by using the scanning frame is displayed.

In this embodiment, the computer device displays the scanning frame in response to the resurrection skill selection operation. In this case, there is no need to enter the scanning mode during a current game match. The computer device may directly aim and accurately select the first killed individual by using the scanning frame, to display the character information of the first virtual character corresponding to the first killed individual selected by using the scanning frame, so as to improve efficiency of human-computer interaction. In addition, the character information of the virtual character can be displayed only by performing, in a current mode, the resurrection skill selection operation, without a need of switching from the current mode to the scanning mode and from the scanning mode back to the current mode. This helps reduce resource consumption caused by mode switching.

2. A second display manner of the character information of the first virtual character.

In some embodiments, the second display manner may be further determined based on the first display manner. Operation 342 may be further implemented as operation 346, and operation 344 may be further implemented as operation 348.

Operation 346: Display the scanning frame and display a movable carrier in response to the resurrection skill selection operation.

The movable carrier is any movable object in the virtual environment. Movable may refer to an attribute of the object, or may refer to being capable of moving after being controlled by a player or being interacted with a player. For example, the movable carrier may be a movable non-player character (NPC) or virtual animal, or may be at least one of a virtual vehicle, a virtual flying object, and a virtual flying vehicle that can move after being controlled.

The movable carrier is an object that is in the virtual environment and that can interact with a main control virtual character currently controlled by a player. For example, the movable carrier may be an NPC in a current game match, a virtual character of another player, or a virtual pet character (pet sprite) owned by a main control virtual character of a player in a current game match.

For example, in response to the resurrection skill selection operation, the computer device displays the scanning frame and simultaneously displays the movable carrier. The scanning frame does not overlap the movable carrier.

In some embodiments, the movable carrier is bound with an idle animation. The computer device displays the scanning frame, displays the movable carrier, and automatically plays back the idle animation of the movable carrier in response to the resurrection skill selection operation. The idle animation of the movable carrier may be an animation that is preset for the movable carrier and that is automatically played back during display of the movable carrier. In one embodiment, the idle animation of the movable carrier may be set by a technical person, or may be set by a player, which is not limited in embodiments of this application. The idle animation of the movable carrier is automatically played back during the display of the movable carrier. This can enrich a picture display effect and improve a visual effect, to improve efficiency of human-computer interaction.

In one embodiment, the movable carrier may also be referred to as an interactive object, and can interact with a player.

Operation 348: Display, in a peripheral area of the movable carrier, the character information of the first virtual character corresponding to the first killed individual selected by using the scanning frame. A display position of the character information of the first virtual character moves with the movable carrier.

The peripheral area is an area around the movable carrier.

In one embodiment, the peripheral area is any area of a 360-degree surrounding area of the movable carrier. In one embodiment, the peripheral area may be one of an upper area, a lower area, a left area, and a right area of the movable carrier.

In one embodiment, the peripheral area is an area whose distance to a central position of the movable carrier is less than a distance threshold. In one embodiment, the peripheral area may be one of an area that is in the upper area of the movable carrier and whose distance to the central position of the movable carrier is less than a distance threshold, an area that is in the lower area and whose distance to the central position of the movable carrier is less than a distance threshold, an area that is in the left area and whose distance to the central position of the movable carrier is less than a distance threshold, and an area that is in the right area and whose distance to the central position of the movable carrier is less than a distance threshold.

The computer device displays, in the peripheral area of the movable carrier, the character information of the first virtual character corresponding to the first killed individual selected by using the scanning frame.

In one embodiment, the character information of the first virtual character is bound to the movable carrier. Because the movable carrier is movable, a position of the movable carrier changes after the movable carrier is moved. Therefore, the character information of the first virtual character is displayed with movement of the movable carrier. In other words, the display position of the character information of the first virtual character moves with the movable carrier. In a manner in which the display position of the character information of the first virtual character moves with the movable carrier, the position of the character information of the first virtual character relative to the movable carrier remains unchanged. For example, assuming that the peripheral area is the upper area of the movable carrier, regardless of which position the movable carrier moves to, the character information of the first virtual character is always displayed in the upper area of the movable carrier.

Further, operation 348 may be specifically implemented as operation 350 and operation 352.

Operation 350: Display an information panel in the peripheral area of the movable carrier.

The information panel is a panel configured for displaying specific content of the character information. In some embodiments, the information panel is a panel whose size is fixed. In some other embodiments, the information panel is a panel whose size is variable. For example, the information panel is a panel whose size may be changed based on a scenario included in a game match. For another example, the information panel is a panel whose size may be changed based on a type of a main control virtual character controlled by a player.

For example, before displaying the character information of the first virtual character corresponding to the first killed individual selected by using the scanning frame, the computer device first displays the information panel in the peripheral area of the movable carrier.

In some embodiments, the information panel provides a perspective function. To be specific, the information panel does not block a virtual item in the virtual environment, and when a virtual item is located behind the information panel, the virtual item can still be seen through the information panel.

Operation 352: Display, in the information panel, the character information of the first virtual character corresponding to the first killed individual selected by using the scanning frame, a display position of the information panel moving with the movable carrier.

In some embodiments, the information panel provides a movement function. The information panel can be displayed with movement of the movable carrier, and the information panel may be bound to the movable carrier. For example, the computer device displays, in the information panel, the character information of the first virtual character corresponding to the first killed individual selected by using the scanning frame. The information panel is displayed with the movement of the movable carrier, to achieve an effect that the character information is displayed with the movement of the movable carrier.

In other words, the display position of the information panel moves with the movable carrier, to achieve an effect that the display position of the character information moves with the movable carrier. In a manner in which the display position of the information panel moves with the movable carrier, the position of the information panel relative to the movable carrier remains unchanged. For example, assuming that the peripheral area is the upper area of the movable carrier, regardless of which position the movable carrier moves to, the information panel is always displayed in the upper area of the movable carrier.

In this embodiment, the computer device displays the scanning frame and displays the movable carrier in response to the resurrection skill selection operation. Because the position of the movable carrier may change, when the character information is displayed on the peripheral area of the movable carrier, in comparison with a manner of directly overlaying the character information on an HUD on a UI plane layer, or only providing, in a virtual scenario, a non-movable panel for overlaying the character information, flexibility and diversity of character information display can be increased, and a visual effect is improved, to improve efficiency of human-computer interaction.

In some embodiments, an example in which the movable carrier is the virtual pet character (pet sprite) is used for description. In this case, the movable carrier includes the virtual pet character, and the peripheral area of the movable carrier includes an area directly above the head of the virtual pet character. The area directly above the head of the virtual pet character is an area located directly above the head of the virtual pet character. Directly above the head of the virtual pet character refers to a direction that is perpendicular to the head of the virtual pet character and away from the foot of the virtual pet character.

In one embodiment, the computer device displays the scanning frame and displays the virtual pet character in response to the resurrection skill selection operation; and displays, in the area directly above the head of the virtual pet character, the character information of the first virtual character corresponding to the first killed individual selected by using the scanning frame.

In some embodiments, the information panel of the character information is parallel to a front side of the virtual pet character. In addition, the information panel is displayed with movement of the virtual pet character, to achieve an effect that the character information is displayed with the movement of the virtual pet character. In other words, the display position of the information panel moves with the virtual pet character, to achieve an effect that the display position of the character information moves with the virtual pet character. Based on this, the computer device acquires first plane information corresponding to the front side of the virtual pet character; calculates, based on the first plane information, second plane information corresponding to the information panel on which the character information is located, the information panel being parallel to the front side of the virtual pet character; and displays the information panel in the area directly above the head of the virtual pet character based on the second plane information, and displays, in the information panel, the character information of the first virtual character corresponding to the first killed individual selected by using the scanning frame.

The first plane information is plane information that corresponds to the front side of the virtual pet character and that is acquired in real time. For example, the front side of the virtual pet character is a plane perpendicular to a facial orientation of the virtual pet character. The first plane information includes a coordinate-based front side orientation of the virtual pet character, which is represented as (X, Y, Z). The coordinate-based front side orientation of the virtual pet character may also be understood as the facial orientation that is of the virtual pet character and that is represented by using coordinates.

The second plane information is plane information that is acquired based on the first plane information and that corresponds to the information panel. The second plane information includes a coordinate-based orientation of the information panel, which is represented as (X, Z), where Y=0. In other words, the coordinate-based orientation of the information panel is parallel to the facial orientation of the virtual pet character.

In some other embodiments, the computer device may further acquire the first plane information corresponding to the front side of the virtual pet character, determine, based on the first plane information, a plane normal vector corresponding to the front side of the virtual pet character, and then determine a plane normal vector of the information panel based on the plane normal vector corresponding to the front side of the virtual pet character. The plane normal vector corresponding to the front side of the virtual pet character is parallel to the plane normal vector of the information panel. Further, the second plane information corresponding to the information panel is determined based on the plane normal vector of the information panel. Then, the computer device displays the information panel in the area directly above the head of the virtual pet character based on the second plane information, and displays, in the information panel, the character information of the first virtual character corresponding to the first killed individual selected by using the scanning frame.

In this embodiment, the player may interact with the virtual pet character, and the virtual pet character may drive the character information to move during an activity. This can add a movement trajectory to the character information, to increase flexibility and diversity of character information display, and help improve a visual effect, so as to improve efficiency of human-computer interaction.

In the foregoing embodiment, the computer device displays the scanning frame and displays a movable carrier in response to the resurrection skill selection operation. A user selects the first killed individual from the at least one killed individual by using the scanning frame. The computer device displays the character information of the first virtual character corresponding to the first killed individual in the peripheral area of the movable carrier.

In some other embodiments, the computer device may recommend the first killed individual from the at least one killed individual based on at least one of attribute information of the movable carrier, attribute information of the main control virtual character initiating a resurrection skill, and attribute information of a virtual character corresponding to a killed individual.

The attribute information of the movable carrier is configured for describing an attribute of the movable carrier. The main control virtual character initiating the resurrection skill is a virtual character currently controlled by a player of the computer device, and the attribute information of the main control virtual character is configured for describing an attribute of the main control virtual character. The attribute information of the virtual character corresponding to the killed individual is configured for describing an attribute of the virtual character corresponding to the killed individual.

In one embodiment, the attribute information of the movable carrier includes at least one of a type, a level, a personality, and a gender of the movable carrier. The movable carrier may be specifically a virtual pet character. The attribute information of the main control virtual character includes at least one of a type, a level, a personality, a gender, and resurrection skill power of the main control virtual character. The attribute information of the virtual character corresponding to the killed individual includes at least one of a type, a level, a gender, a personality, and a resurrection difficulty of the virtual character corresponding to the killed individual. In one embodiment, the computer device recommends the first killed individual from the at least one killed individual based on at least one of the following factors:
the type of the movable carrier;
the level of the movable carrier;
a type matching degree between the virtual character corresponding to the killed individual and the movable carrier;
a level matching degree between the virtual character corresponding to the killed individual and the movable carrier;
a personality matching degree between the virtual character corresponding to the killed individual and the movable carrier;
gender matching degrees separately between virtual characters corresponding to killed individuals and the movable carrier;
a matching degree between the resurrection skill power of the main control virtual character and the resurrection difficulty of the virtual character corresponding to the killed individual;
a distance between the movable carrier and the virtual character corresponding to the killed individual; and
a distance between the main control virtual character and the virtual character corresponding to the killed individual.

In one embodiment, the type of the movable carrier may be one of animal, person, and pet, and the level may be one of primary, intermediate, and advanced. Movable carriers of different types and/or levels supports display of character information of different virtual characters. The computer device may use, as the first killed individual, a killed individual corresponding to a virtual character whose character information is supported by the movable carrier for display. For example, three killed individuals are displayed on the user interface, and correspond to a virtual character 1, a virtual character 2, and a virtual character 3. A type and a level of a movable carrier 1 can only support display of character information of the virtual character 2 and the virtual character 3. In this case, the computer device may recommend, to the user, killed individuals/a killed individual corresponding to the virtual character 2 and/or the virtual character 3 as first killed individuals/the first killed individual.

For example, in a case in which the first killed individual is determined only based on the type of the movable carrier, a killed individual corresponding to a virtual character whose character information is supported by the type of the movable carrier for display is used as the first killed individual.

For example, in a case in which the first killed individual is determined only based on the level of the movable carrier, a killed individual corresponding to a virtual character whose character information is supported by the level of the movable carrier for display is used as the first killed individual.

For example, in a case in which the first killed individual is determined based on the type and the level of the movable carrier, a union of a first-type killed individual and a second-type killed individual may be used as the first killed individual, or an intersection of the first-type killed individual and the second-type killed individual may be used as the first killed individual, or one or more killed individuals are selected from the first-type killed individual and the second-type killed individual as the first killed individuals. The first-type killed individual is a killed individual corresponding to a virtual character whose character information is supported by the type of the movable carrier for display, and the second-type killed individual is a killed individual corresponding to a virtual character whose character information is supported by the level of the movable carrier for display.

In one embodiment, the computer device may determine the type matching degree between the virtual character corresponding to the killed individual and the movable carrier. The type matching degree may be displayed in the character information. For example, the type matching degree between the virtual character corresponding to the killed individual and the movable carrier is configured for measuring a matching degree between the type of the virtual character corresponding to the killed individual and the type of the movable carrier. For example, different vectors may be used to represent different types, so that the type matching degree is determined by calculating a similarity between a vector corresponding to the type of the virtual character corresponding to the killed individual and a vector corresponding to the type of the movable carrier. The similarity is in a positive correlation with the type matching degree.

The computer device may determine, as the first killed individual, a killed individual whose type matching degree is the highest or whose type matching degree is higher than a threshold. For example, a virtual character 1 corresponding to a killed individual 1 is good at driving, a virtual character 2 corresponding to a killed individual 2 is good at piloting an aircraft, and the movable carrier is a virtual vehicle. A type matching degree between the virtual character corresponding to the killed individual 1 and the movable carrier is greater than a type matching degree between the virtual character corresponding to the killed individual 2 and the movable carrier. In this case, the computer device may determine the killed individual 1 as the first killed individual.

In one embodiment, the computer device may determine the level matching degree between the virtual character corresponding to the killed individual and the movable carrier. The level matching degree may be displayed in the character information. For example, the level matching degree between the virtual character corresponding to the killed individual and the movable carrier is configured for measuring a matching degree between the level of the virtual character corresponding to the killed individual and the level of the movable carrier. For example, the level of the virtual character corresponding to the killed individual may be a level of the virtual character that corresponds to the killed individual and that has not been killed. For example, the level may be represented by using a value. The level matching degree may be determined by calculating a similarity between a value corresponding to the level of the virtual character corresponding to the killed individual and a value corresponding to the level of the movable carrier. The similarity is in a positive correlation with the level matching degree.

The computer device may determine, as the first killed individual, a killed individual whose level matching degree is the highest or whose level matching degree is higher than a threshold. For example, a level of a virtual character 1 that corresponds to a killed individual 1 and that has not been killed is level 10, a level of a virtual character 2 that corresponds to a killed individual 2 and that has not been killed is level 3, and a level of the movable carrier is level 9. A level matching degree between the virtual character corresponding to the killed individual 1 and the movable carrier is greater than a level matching degree between the virtual character corresponding to the killed individual 2 and the movable carrier. In this case, the computer device may determine the killed individual 1 as the first killed individual.

In one embodiment, the computer device may determine the personality matching degree between the virtual character corresponding to the killed individual and the movable carrier. The personality matching degree may be displayed in the character information. For example, the personality matching degree between the virtual character corresponding to the killed individual and the movable carrier is configured for measuring a matching degree between the personality of the virtual character corresponding to the killed individual and the personality of the movable carrier. For example, different vectors may be used to represent different personalities, so that the personality matching degree can be determined by calculating a similarity between a vector corresponding to the personality of the virtual character corresponding to the killed individual and a vector corresponding to the personality of the movable carrier. The similarity is in a positive correlation with the personality matching degree.

The computer device may determine, as the first killed individual, a killed individual whose personality matching degree is the highest or whose personality matching degree is higher than a threshold. For example, a personality of a virtual character 1 corresponding to a killed individual 1 is favored to combat, a personality of a virtual character 2 corresponding to a killed individual 2 is favored to hide, and a personality of the movable carrier is favored to combat. A personality matching degree between the virtual character corresponding to the killed individual 1 and the movable carrier is greater than a personality matching degree between the virtual character corresponding to the killed individual 2 and the movable carrier. In this case, the computer device may determine the killed individual 1 as the first killed individual.

In one embodiment, the computer device may determine the gender matching degree between the virtual character corresponding to the killed individual and the movable carrier. The gender matching degree may be displayed in the character information. For example, the gender matching degree between the virtual character corresponding to the killed individual and the movable carrier is configured for measuring a matching degree between the gender of the virtual character corresponding to the killed individual and the gender of the movable carrier. The gender of the movable carrier may be a gender of the movable carrier, or may be a gender favored by the movable carrier. For example, if the gender of the virtual character corresponding to the killed individual is the same as the gender of the movable carrier, a first matching degree is used as the gender matching degree. If the gender of the virtual character corresponding to the killed individual is different from the gender of the movable carrier, a second matching degree is used as the gender matching degree. The first matching degree is greater than the second matching degree.

The computer device may determine, as the first killed individual, a killed individual whose gender matching degree is the highest or whose gender matching degree is higher than a threshold. For example, a gender of a virtual character 1 corresponding to a killed individual 1 is male, a gender of a virtual character 2 corresponding to a killed individual 2 is female, and a gender favored by the movable carrier is male. A gender matching degree between the virtual character corresponding to the killed individual 1 and the movable carrier is greater than a gender matching degree between the virtual character corresponding to the killed individual 2 and the movable carrier. In this case, the computer device may determine the killed individual 1 as the first killed individual.

In one embodiment, the computer device may determine the matching degree between the resurrection skill power of the main control virtual character and the resurrection difficulty of the virtual character corresponding to the killed individual. The matching degree may be displayed in the character information. The varying difficulty of resurrecting a virtual character corresponding to a killed individual matches different resurrection skill power. For example, the resurrection difficulty is 50%, and a power value of needed resurrection skill power is at least 100. For example, the computer device may determine resurrection skill power corresponding to the resurrection difficulty of the virtual character corresponding to the killed individual, and determine, based on a similarity between the determined resurrection skill power and the resurrection skill power of the main control virtual character, the matching degree between the resurrection skill power of the main control virtual character and the resurrection difficulty of the virtual character corresponding to the killed individual. The similarity is in a positive correlation with the matching degree. The computer device may determine, as the first killed individual, a killed individual whose matching degree is the highest or whose matching degree is higher than a threshold.

In one embodiment, the computer device may determine the distance between the movable carrier and the virtual character corresponding to the killed individual. The distance may be displayed in the character information. For example, the distance between the movable carrier and the virtual character corresponding to the killed individual is a distance between a position of the movable carrier and a position of the virtual character that corresponds to the killed individual and that has not been killed. The computer device may determine, as the first killed individual, a killed individual whose distance is the shortest or whose distance is less than a threshold.

In one embodiment, the computer device may determine the distance between the main control virtual character and the virtual character corresponding to the killed individual. The distance may be displayed in the character information. For example, the distance between the main control virtual character and the virtual character corresponding to the killed individual is a distance between a position of the main control virtual character and a position of the virtual character that corresponds to the killed individual and that has not been killed. The computer device may determine, as the first killed individual, a killed individual whose distance is the shortest or whose distance is less than a threshold. The foregoing thresholds may be set based on an actual technical requirement, and specific values of the thresholds may be different.

In some other embodiments, the computer device may recommend the first killed individual from the at least one killed individual based on a dialog statement between the movable carrier and the main control virtual character initiating the resurrection skill.

Specifically, the movable carrier provides a dialog function, and a dialog may be allowed between the main control virtual character and the movable carrier. A trained natural language processing model is installed and run in the computer device. The dialog statement between the main control virtual character and the movable carrier is input into the natural language processing model, and the first killed individual is selected from the at least one killed individual based on the natural language processing model. The movable carrier may be a virtual pet character or an NPC.

At a training stage of the natural language processing model, a sample statement is annotated with attribute information such as a type and a personality of each virtual character matching the sample statement. Therefore, the natural language processing model has a capability of determining a matched killed individual based on the dialog statement between the main control virtual character and the movable carrier. For example, the main control virtual character says to the movable carrier that: “please help me to select a to-be-resurrected subject with the strongest output.” In this case, the natural language processing model analyzes the dialog statement, and selects the first killed individual from the at least one killed individual. The first virtual character corresponding to the first killed individual has the strongest output among virtual characters corresponding to killed individuals.

In the foregoing embodiment, a plurality of methods of selecting the first killed individual from the at least one killed individual are provided. This can increase an association and a coupling degree between the movable carrier and a selection process of selecting a killed individual, so that the movable carrier has a character information display function, and also has a higher participation degree in a game. In this manner, game play methods can be increased and user experience is effectively improved, to improve efficiency of human-computer interaction.

In some embodiments, another killed individual may be further selected from the at least one killed individual by moving the scanning frame. Based on the embodiments of the foregoing two display manners, the method further includes operation 420 and operation 440.

Operation 420: Display the moved scanning frame in response to a move operation, the moved scanning frame being configured for selecting a second killed individual of the at least one killed individual.

The move operation may be an operation after the resurrection skill selection operation and before the resurrection skill casting operation. Alternatively, the move operation may be a latter part of the resurrection skill selection operation. For example, a user touches and holds a resurrection operation button to trigger the resurrection skill selection operation, and moves or rotates a finger during the touching and holding, to implement movement of the scanning frame.

The second killed individual is one of the at least one killed individual that is reselected through the resurrection skill selection operation, and the second killed individual is a display element corresponding to a second virtual character after being killed. The second killed individual and the first killed individual are different killed individuals. For example, there may be one or more first killed individuals, there may be one or more second killed individuals, and a quantity of first killed individuals may be the same as or different from a quantity of second killed individuals. That the second killed individual and the first killed individual are different killed individuals means that the second killed individual and the first killed individual are totally different or partially different.

For example, the computer device displays the moved scanning frame in response to the move operation, the moved scanning frame being configured for selecting a second killed individual of the at least one killed individual.

Operation 440: Display character information of a second virtual character corresponding to the second killed individual selected by using the moved scanning frame.

For example, the computer device displays the character information of the second virtual character corresponding to the second killed individual selected by using the moved scanning frame. A display manner of the character information of the second virtual character corresponding to the second killed individual is the same as the display manner of the character information of the first virtual character corresponding to the first killed individual. Details are not described herein.

In this embodiment, the computer device can display the character information of the first virtual character corresponding to the first killed individual selected by using the scanning frame, and can switch to display the character information of the second virtual character corresponding to the second killed individual selected by using the moved scanning frame, so that flexibility of character information display is improved, to improve interaction experience and efficiency of human-computer interaction.

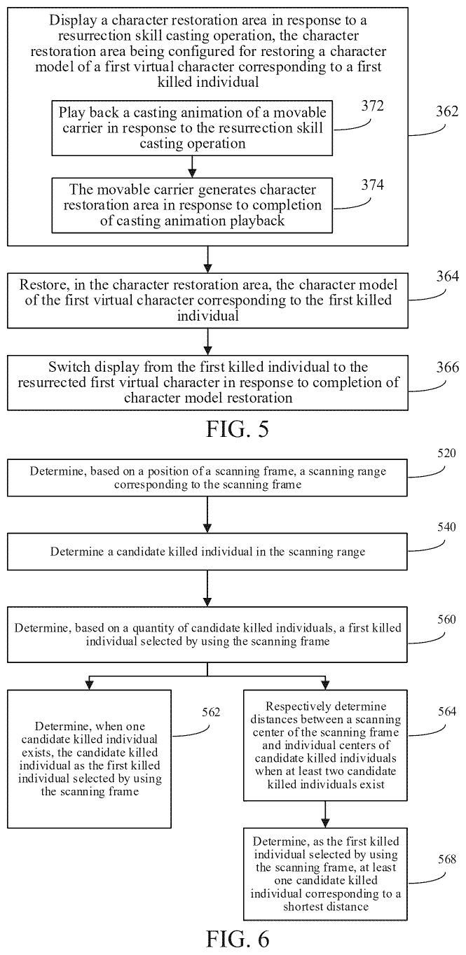

In some embodiments, refer to FIG. 5. Operation 360 may be implemented as operation 362, operation 364, and operation 366.

Operation 362: Display a character restoration area in response to the resurrection skill casting operation, the character restoration area being configured for restoring a character model of the first virtual character corresponding to the first killed individual.

The character restoration area is an area configured for restoring the character model of the first virtual character corresponding to the first killed individual. In one embodiment, during restoration of character models of different virtual characters, character restoration areas are different in respect of at least one of position, size, and shape. For example, a shape of the character restoration area may be cylindrical, rectangular, square, or the like. For example, the character restoration area is located directly in front of a killed individual of a to-be-resurrected virtual character. Because different first killed individuals are located at different positions, character restoration areas configured for restoring character models of first virtual characters corresponding to different first killed individuals are located at different positions.

For example, the computer device displays the character restoration area in response to the resurrection skill casting operation, the character restoration area being configured for restoring a character model of the first virtual character corresponding to the first killed individual.

Operation 364: Restore, in the character restoration area, the character model of the first virtual character corresponding to the first killed individual.

The character model is configured to represent a character image of the first virtual character, and the character model may be a three-dimensional model, a two-dimensional model, or the like. All or at least a part of the character model is the same as a character model of the first virtual character before being killed.

For example, costumes, gestures, items, and the like of the character model of the first virtual character corresponding to the first killed individual are the same as those of the character model of the first virtual character before being killed. A halo icon may be further added directly above the head of the character model of the first virtual character corresponding to the first killed individual, to indicate that the first virtual character is the resurrected first virtual character.

In one embodiment, the computer device restores, in the character restoration area, the character model of the first virtual character corresponding to the first killed individual.

Operation 366: Switch display from the first killed individual to the resurrected first virtual character in response to completion of character model restoration.

In one embodiment, the computer device switches the display from the first killed individual to the resurrected first virtual character in response to the completion of the character model restoration. In this case, the computer device cancels display of a display element corresponding to the first killed individual, and display content of another non-resurrected virtual character remains unchanged.

In this embodiment, the computer device may switch the display from the first killed individual to the resurrected first virtual character by restoring the character model of the first virtual character. This can ensure smoothness of display.

Further, when the movable carrier is displayed on the user interface, and the character information is displayed in the peripheral area of the movable carrier simultaneously, operation 362 may be implemented as operation 372 and operation 374.

Operation 372: Play back a casting animation of the movable carrier in response to the resurrection skill casting operation.

The casting animation is an animation in which the movable carrier moves from a current position to a position of the to-be-resurrected virtual character. The casting animation is configured for representing casting the resurrection skill to the first virtual character corresponding to the first killed individual. The casting animation may be bound to the type of the movable carrier, or may be a preset unified animation. For example, the movable carrier is a virtual pet character, and the casting animation is that the virtual pet character flies from a current position to a position directly in front of the position of the to-be-resurrected virtual character. In this case, the computer device plays back, in response to the resurrection skill casting operation, the casting animation in which the virtual pet character flies from the current position to the position directly in front of the position of the to-be-resurrected virtual character.

In one embodiment, the computer device plays back the casting animation of the movable carrier in response to the resurrection skill casting operation.

Operation 374: Display the character restoration area in response to completion of casting animation playback.

In one embodiment, the character restoration area may be transformed from the movable carrier. For example, the computer device displays, in response to completion of casting animation playback, the character restoration area transformed from the movable carrier, and then restores the character model of the first virtual character in the character restoration area.

In this embodiment, the computer device plays back the casting animation of the movable carrier in response to the resurrection skill casting operation, and then displays the character restoration area when playback of the casting animation is completed, so that a coupling degree between the movable carrier and a resurrection process of a virtual character is higher, to increase flexibility of display, so as to increase a display effect, and improve efficiency of human-computer interaction.

FIG. 6 is a flowchart of a virtual environment-based interaction method according to an exemplary embodiment of this application. In some embodiments, when receiving a resurrection skill selection operation, a computer device may determine, based on a position of a scanning frame in this case, a first killed individual selected through the resurrection skill selection operation. Specifically, the method further includes operation 520, operation 540, and operation 560.

Operation 520: Determine, based on a position of the scanning frame, a scanning range corresponding to the scanning frame.

The scanning range corresponding to the scanning frame may be a fixed range, or may be determined based on at least one of an amount of health points, a level, and resurrection skill power of a main control virtual character currently controlled by a player. A size of the scanning range may be separately in a positive correlation with the amount of health points, the level, and the resurrection skill power.

For example, the position of the scanning frame may include a central position of the scanning frame, and the scanning range corresponding to the scanning frame may be a range centered around the central position of the scanning frame.

For example, the computer device determines, based on the position of the scanning frame, the scanning range corresponding to the scanning frame.

Operation 540: Determine a candidate killed individual in the scanning range.

The candidate killed individual is at least one killed individual that is in the scanning range of the scanning frame and that may be selected as the first killed individual.

For example, the computer device determines the candidate killed individual in the scanning range.

Operation 560: Determine, based on a quantity of candidate killed individuals, the first killed individual selected by using the scanning frame.

In one embodiment, the computer device determines, based on the quantity of candidate killed individuals, the first killed individual selected by using the scanning frame. Specifically, the following two cases may be included.

First case: Operation 560 may be implemented as operation 562.

Operation 562: Determine, when one candidate killed individual exists, the candidate killed individual as the first killed individual selected by using the scanning frame.

For example, when one candidate killed individual exists, the computer device directly determines the candidate killed individual as the first killed individual selected by using the scanning frame.

Second case: Operation 560 may be implemented as operation 564 and operation 568.

Operation 564: Respectively determine distances between a scanning center of the scanning frame and individual centers of candidate killed individuals when at least two candidate killed individuals exist.

The distances are straight-line distances or projection straight-line distances between the scanning center of the scanning frame and the individual centers of the candidate killed individuals.

In one embodiment, the computer device respectively determines the distances between the scanning center of the scanning frame and the individual centers of the candidate killed individuals when the at least two candidate killed individuals exist.

Operation 568: Determine, as the first killed individual selected by using the scanning frame, at least one candidate killed individual corresponding to a shortest distance.

In one embodiment, the computer device determines, as the first killed individual selected by using the scanning frame, the at least one candidate killed individual corresponding to the shortest distance. The shortest distance is a minimum value of the distances between the scanning center of the scanning frame and the individual centers of the candidate killed individuals.

In this embodiment, the computer device determines the candidate killed individual in the scanning range of the scanning frame, and determines, based on the distances between the scanning center of the scanning frame and the individual centers of the candidate killed individuals, the first killed individual selected by using the scanning frame. This can improve selection accuracy.

To understand the virtual environment-based interaction method provided in embodiments of this application more clearly, the following describes the method with reference to a schematic diagram of a specific user interface. The method is performed by a computer device.

In a related art, there are the following several problems.

1. Most scan locking operations require media such as cameras or unmanned aerial vehicles, and cannot be direct aiming. For example, a scanning mode can be triggered only through virtual scene scanning or a special medium. A function supporting HUD during direct aiming is basically not provided. This results in a loss of some of convenience and quick use functions.

2. During scan locking, candidate objects in a virtual scenario are all specific models. For example, a scanned object is usually a specific virtual person, virtual prop, virtual item, or the like. After being killed, a player may become a “box”, a soul, or the like in the virtual scenario, and features of the player basically disappear. In this case, objects cannot be quickly distinguished and identified in this special virtual scenario.

3. Display of information in most games is directly overlaying the information on an HUD on a UI plane layer, or only providing, in a virtual scenario, a non-movable panel for overlaying the information. Interactivity and flexibility of this display manner are not strong.

In the method provided in embodiments of this application, the foregoing several problems can be resolved. When a player having a resurrection skill or another special skill wants to cast the resurrection skill, the player can accurately and quickly recognize a teammate identity when facing a virtual scenario special effect indicating that an identity model feature has lost. In the method, character information of a virtual character corresponding to a selected killed individual may be displayed by using a movable carrier in the virtual scenario. In addition, the displayed character information is bound to the movable carrier. Because the movable carrier has its own movement trajectory, and simultaneously drives the character information to move, interactivity and flexibility in a game are improved. A design of the movable carrier can also satisfy game world views and character design expressions, so that effect of displaying the character information can be achieved, and emotional design can also be conveyed.

For example, a frontend implementation of the virtual environment-based interaction method may include the following operations.

1. There are three teammates in a virtual scenario, and the teammates are in a normal survival state. As shown in a user interface 710 in FIG. 7, three surviving virtual characters are displayed on the user interface 710, which are respectively a virtual character 712, a virtual character 713, and a virtual character 714. A resurrection operation button 711 is further displayed on the user interface 710.

2. After a teammate is killed, the teammate gradually changes to be a soul (killed individual). Using an example in which the virtual character 712 is killed, as shown in a user interface 720 in FIG. 7, after the virtual character 712 is killed, a killed individual of the virtual character 712 after being killed is displayed in a display form 721 of upward-floating particles. For example, display elements corresponding to the virtual character 712, the virtual character 713, and the virtual character 714 after being killed are all block elements.

3. When entering a skill preselection state, a player calls out a movable carrier (sprite on a palm) from a hand of the player, and the sprite has its own bound idle action. At the same time, a crosshair (scanning frame) changes to be in a scanning state. In this case, there are killed individuals (to-be-resurrected souls) of the three teammates in the virtual scenario. As shown in a user interface 730 in FIG. 8, a killed individual 731 of the virtual character 712 after being killed, a killed individual 732 of the virtual character 713 after being killed, and a killed individual 733 of the virtual character 714 after being killed are displayed on the user interface 730, the killed individual 731, the killed individual 732, and the killed individual 733 are displayed in the same display form, and all are displayed as block elements with upward-floating particles (block light beams). A palm 736, a sprite 735 on the palm 736, and a crosshair 734 in the scanning state are further displayed on the user interface 730.

4. Select a teammate soul (first killed individual) that is closest to a center of the crosshair, where the crosshair changes to be in a locked state, and character information of the selected teammate soul is quickly displayed above the head of the sprite. As shown in a user interface 740 in FIG. 8, a first killed individual 731 is selected by using a resurrection operation button 711, the crosshair 734 in the scanning state is switched to a crosshair 741 in the locked state, and character information 742 of a first virtual character corresponding to the first killed individual 731 is quickly displayed above the head of the sprite.

5. If the crosshair is moved away during display in operation 4, reselect a teammate soul that is closest to the center of the crosshair, and regenerate character information corresponding to the selected teammate soul. As shown in a user interface 750 in FIG. 8, the crosshair is moved away by using the resurrection operation button 711. In this case, a second killed individual 751 is selected, and character information 752 of a second virtual character corresponding to the second killed individual 751 is quickly displayed above the head of the sprite.

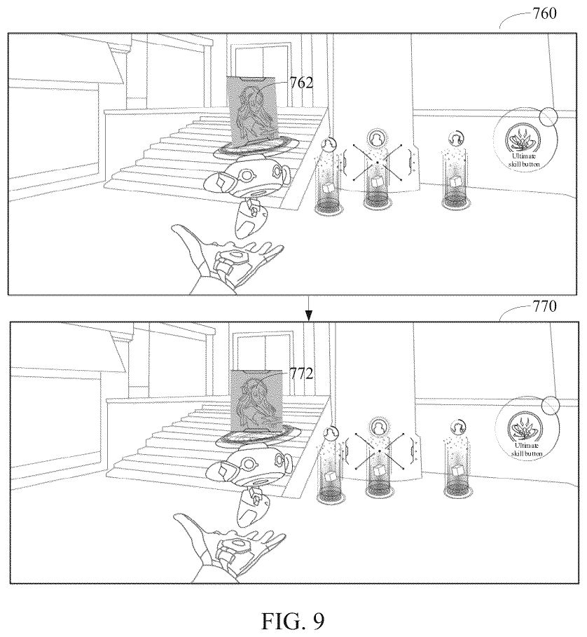

6. Completely display, in an information panel above the head of the sprite, the character information corresponding to the selected teammate soul. As shown in a user interface 760 in FIG. 9, all character information 762 of the second virtual character corresponding to the second killed individual 751 is fully displayed above the head of the sprite.

7. The information panel is bound to the head of the sprite to move, moves with the sprite, and features built-in perspective and motion, making it more flexible and dynamic compared with an HUD plane or a carrier fixed in a virtual scenario. As shown in a user interface 770 in FIG. 9, the head of the sprite is rotated by a particular angle. In this case, the information panel 762 is also rotated by a particular angle and displayed as an information panel 772, so that the information panel is always parallel to a front side of the sprite.

8. After confirming a to-be-resurrected teammate through the information panel, the player releases the resurrection operation button to indicate confirmation of casting of the resurrection skill. In this case, a casting animation is entered, where the sprite flies out from the hand of the player, to enter a teammate resurrection stage. As shown in a user interface 780 in FIG. 10, the player releases the resurrection operation button to confirm casting of the resurrection skill, the sprite flies out from the hand of the player, and a flying animation 782 in which the sprite flies out from a current position to the front of the to-be-resurrected teammate soul is displayed on the user interface 780.

9. After flying out, the sprite generates a teammate resurrection station (character restoration area) in front of the to-be-resurrected teammate soul and starts to print a teammate model to resurrect the teammate. As shown in a user interface 790 in FIG. 10, after flying out, the sprite generates a teammate resurrection station 792 in front of the to-be-resurrected teammate soul, and starts to print a teammate model 793. As shown in a user interface 800 in FIG. 10, after printing of the teammate model is completed, a teammate model 802 is displayed on the user interface 800. In this case, the teammate is resurrected, and returns to a current game match.

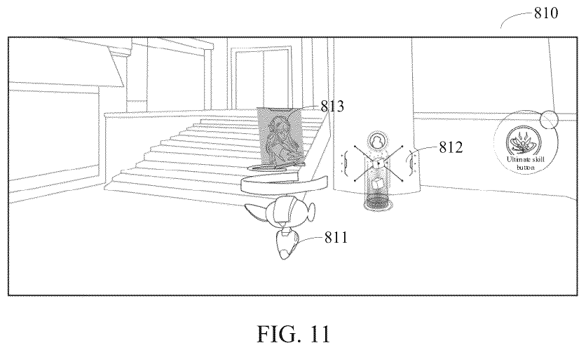

In some embodiments, the foregoing method may alternatively be applied from a perspective of the movable carrier. In this case, only a main perspective is changed, and other interactive behaviors remain reusable. As shown in a user interface 810 in FIG. 11, the user interface is displayed from the perspective of the movable carrier, and a scanning frame 812, a sprite 811, and an information panel 813 can be still displayed on the user interface 810.

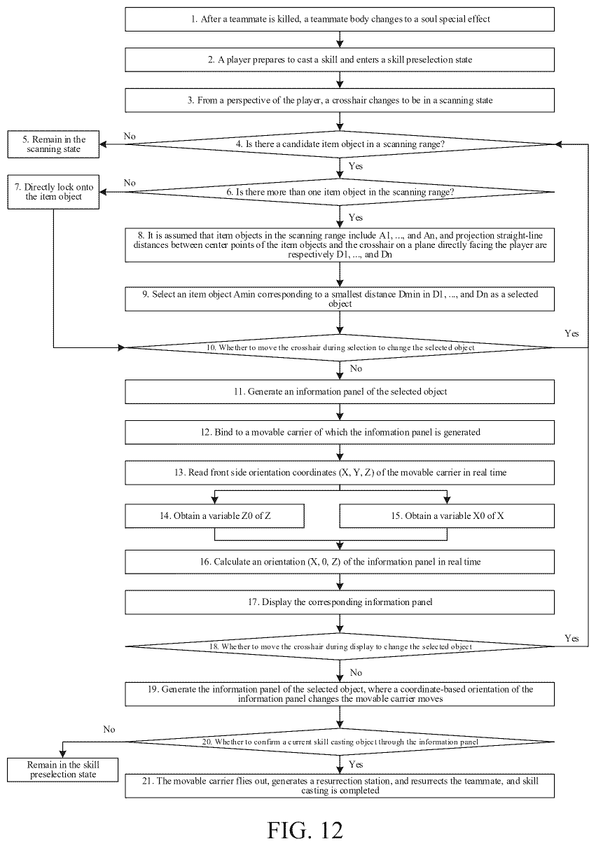

For example, a backend implementation of the virtual environment-based interaction method may be shown in FIG. 12. FIG. 12 is a schematic diagram of a virtual environment-based interaction method according to an exemplary embodiment of this application. Overall operations of the method are as follows.

1. After a teammate is killed, a teammate body changes to a soul special effect (block with upward-floating particles). Perform 2.

2. A player prepares to cast a skill and enters a skill preselection state. Perform 3.

3. From a perspective of the player, a crosshair (scanning frame) changes to be in a scanning state. Perform 4.

4. Determine whether there is a selectable item object (candidate killed individual) in a scanning range of the crosshair. If yes, perform 6; or if no, perform 5.

5. There is no candidate item object in the scanning range of the crosshair, and the crosshair continues remaining in the scanning state.

6. There is a candidate item object in the scanning range of the crosshair. Determine whether there is more than one candidate item object in the scanning range of the crosshair. If yes, perform 8; or if no, perform 7.

7. There is only one candidate item object in the scanning range of the crosshair. Directly lock onto the item object and prepare to perform 10.

8. There is more than one candidate item object in the scanning range of the crosshair, and it is assumed that item objects in the scanning range include A1, . . . , and An, and projection straight-line distances between center points of the item objects and the crosshair on a plane directly facing the player are respectively D1, . . . , and Dn. Perform 9.

9. Select an item object Amin corresponding to a smallest distance Dmin in D1, . . . , and Dn as a selected object (first killed individual). Perform 10.

10. Determine whether to move the crosshair during selection to change the selected object. If yes, perform 4 again to redetermine whether there is a selectable item object in the scanning range of the crosshair; or if no, perform 11.

11. The crosshair is not moved during the selection to change the selected object. Generate an information panel of the selected object. Perform 12.

12. Bind to a movable carrier of which the information panel is generated, so that the information panel moves with the movable carrier. Perform 13.

13. Real-time coordinates (X, Y, Z) of the coordinate-based front side orientation of the movable carrier. Synchronously perform 14 and 15.

14. Obtain a variable Z0 of Z. Perform 16.

15. Obtain a variable X0 of X. Perform 16.

16. Calculate an orientation (X, Z) of the information panel in real time by using the coordinates (X, Y, Z) of the coordinate-based front side orientation of the movable carrier, where the Y orientation is 0, to be specific, a facial orientation of the information panel is parallel to that of a sprite. Perform 17.

17. Display the corresponding information panel based on an orientation of the information panel. Perform 18.

18. Determine whether to move the crosshair during display to change the selected object. If yes, stop a process of generating the information panel, and perform 4 again to redetermine whether there is a selectable item object in the scanning range of the crosshair; or if no, perform 19.

19. Generate the information panel of the selected object, where a coordinate-based orientation of the information panel changes as the movable carrier moves. Perform 20.

20. Determine whether the player confirms a current skill casting object through the information panel. If yes, perform 21; or if no, remain the skill preselection state.

21. The player confirms the current skill casting object through the information panel, and enters a skill casting stage, a skill casting animation is played back, where the movable carrier (for example, a sprite) flies out from a hand, generates a resurrection station, and prints a teammate model in the resurrection station, to resurrect the teammate. Skill casting is completed, and the teammate returns to a current game match.

In conclusion, the virtual environment-based interaction method provided in embodiments of this application includes at least the following beneficial effects. 1. Real-time and quick: Without entering any hacking or scanning mode, a player can quickly obtain, only by triggering a resurrection skill selection operation, character information of a virtual character corresponding to a selected killed individual. 2. Strong recognizability: When scanning or needing to select a model that has lost most identity features, a player may be helped to confirm character information through an information panel. 3. Significantly enhanced emotional design: The method avoids general use of a floating panel or an inactive virtual object as a carrier of the information panel, instead, provides a new design concept for projection or imaging application of a movable carrier, so that interactivity and flexibility among the player, the movable carrier, and information display are improved. Based on this, the method can help a player having a resurrection skill accurately select a to-be-resurrected killed individual from a plurality of killed individuals having a same display form or similar display forms, and resurrect, by using the resurrection skill, a virtual character corresponding to the to-be-resurrected killed individual. An operation is simple, and efficiency of human-computer interaction can be improved. In addition, the virtual character can be resurrected only by performing, in a current mode, an operation related to a resurrection skill, without a need of switching from the current mode to the scanning mode and from the scanning mode back to the current mode. This helps reduce resource consumption caused by mode switching.

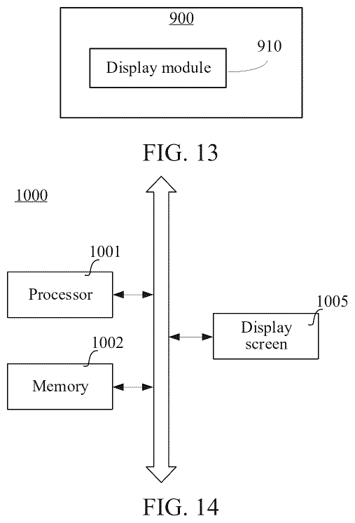

FIG. 13 is a block diagram of a structure of a virtual environment-based interaction apparatus according to an exemplary embodiment of this application. The virtual environment-based interaction apparatus 900 includes:
a display module 910, configured to display at least one killed individual located in a virtual environment, a similarity between display forms of different killed individuals exceeding a threshold,
the display module 910 being configured to display, in response to a resurrection skill selection operation, character information of a first virtual character corresponding to a first killed individual, the first killed individual being a killed individual selected through the resurrection skill selection operation from the at least one killed individual, and the first killed individual being a display element corresponding to the first virtual character after being killed, and
the display module 910 being configured to switch display from the first killed individual to the resurrected first virtual character in response to a resurrection skill casting operation.

In some embodiments, the display module 910 is further configured to display a scanning frame in response to the resurrection skill selection operation, the scanning frame being configured for selecting the first killed individual of the at least one killed individual; and display the character information of the first virtual character corresponding to the first killed individual selected by using the scanning frame.

In some embodiments, the display module 910 is configured to display the scanning frame and display a movable carrier in response to the resurrection skill selection operation; and display, in a peripheral area of the movable carrier, the character information of the first virtual character corresponding to the first killed individual selected by using the scanning frame, a display position of the character information of the first virtual character moving with the movable carrier.

In some embodiments, the display module 910 is further configured to play back an idle animation of the movable carrier.

In some embodiments, the display module 910 is configured to display an information panel in the peripheral area of the movable carrier; and display, in the information panel, the character information of the first virtual character corresponding to the first killed individual selected by using the scanning frame, a display position of the information panel moving with the movable carrier.

In some embodiments, the display module 910 is configured to display the moved scanning frame in response to a move operation, the moved scanning frame being configured for selecting a second killed individual of the at least one killed individual; and display character information of a second virtual character corresponding to the second killed individual selected by using the moved scanning frame.

In some embodiments, the display module 910 is configured to display a character restoration area in response to the resurrection skill casting operation, the character restoration area being configured for restoring a character model of the first virtual character corresponding to the first killed individual; restore, in the character restoration area, the character model of the first virtual character corresponding to the first killed individual; and switch display from the first killed individual to the resurrected first virtual character in response to completion of character model restoration.

In some embodiments, the display module 910 is configured to play back a casting animation of the movable carrier in response to the resurrection skill casting operation; and display the character restoration area in response to completion of casting animation playback.

In some embodiments, the display module 910 is configured to display, in response to the completion of the casting animation playback, the character restoration area transformed from the movable carrier.

In some embodiments, the apparatus further includes a processing module.

In some embodiments, the processing module is configured to determine, based on a position of the scanning frame, a scanning range corresponding to the scanning frame; determine a candidate killed individual in the scanning range; and determine, based on a quantity of candidate killed individuals, the first killed individual selected by using the scanning frame.

In some embodiments, the processing module is configured to respectively determine distances between a scanning center of the scanning frame and individual centers of candidate killed individuals when at least two candidate killed individuals exist; and determine, as the first killed individual selected by using the scanning frame, at least one candidate killed individual corresponding to a shortest distance, the shortest distance being a minimum value of the distances between the scanning center of the scanning frame and the individual centers of the candidate killed individuals.

In some embodiments, the movable carrier includes a virtual pet character, and the peripheral area of the movable carrier includes an area directly above the head of the virtual pet character. The display module 910 is configured to display the scanning frame and display the virtual pet character in response to the resurrection skill selection operation; and display, in the area directly above the head of the virtual pet character, the character information of the first virtual character corresponding to the first killed individual selected by using the scanning frame.

In some embodiments, the processing module is configured to acquire first plane information corresponding to a front side of the virtual pet character; calculate, based on the first plane information, second plane information corresponding to the information panel on which the character information is located, the information panel being parallel to the front side of the virtual pet character; and display the information panel in the area directly above the head of the virtual pet character based on the second plane information, and display, in the information panel, the character information of the first virtual character corresponding to the first killed individual selected by using the scanning frame.

In some embodiments, the display module 910 is configured to recommend the first killed individual from the at least one killed individual in response to the resurrection skill selection operation; and display the character information of the first virtual character corresponding to the recommended first killed individual.

In some embodiments, the display module 910 is configured to recommend the first killed individual from the at least one killed individual based on at least one of the following:
a type of the movable carrier;
a level of the movable carrier;
a type matching degree between the virtual character corresponding to the killed individual and the movable carrier;
a level matching degree between the virtual character corresponding to the killed individual and the movable carrier;
a personality matching degree between the virtual character corresponding to the killed individual and the movable carrier;
a gender matching degree between the virtual character corresponding to the killed individual and the movable carrier;
a matching degree between resurrection skill power of a main control virtual character and a resurrection difficulty of the virtual character corresponding to the killed individual;
a distance between the movable carrier and the virtual character corresponding to the killed individual; and
a distance between the main control virtual character and the virtual character corresponding to the killed individual.

In some embodiments, the display module 910 is configured to acquire a dialog statement between the movable carrier and the main control virtual character initiating a resurrection skill; and input the dialog statement into a natural language processing model, and recommending the first killed individual from the at least one killed individual based on the natural language processing model.

For specific limitations of the one or more embodiments of the virtual environment-based interaction apparatus provided above, refer to limitations on the foregoing virtual environment-based interaction method. Details are not described herein. The modules of the foregoing apparatus can be implemented in whole or in part by software, hardware, and a combination thereof. The modules can be embedded in a processor in a computer device in the form of hardware or independent of the processor in the computer device, and can also be stored in a memory of the computer device in the form of software, so that the processor can invoke and execute corresponding operations of the modules.

FIG. 14 is a block diagram of a structure of a computer device according to an exemplary embodiment of this application.

The computer device 1000 may be a portable mobile terminal, and may also be referred to as a mobile terminal in this embodiment, for example, a smart phone, a tablet computer, a Moving Picture Experts Group Audio Layer III (MP3) player, or a Moving Picture Experts Group Audio Layer IV (MP4) player. The computer device 1000 may also be referred to as another name such as user equipment or a portable terminal.

Generally, the computer device 1000 includes: a processor 1001 and a memory 1002.

The processor 1001 may include one or more processing cores, for example, a 4-core processor or an 8-core processor. The processor 1001 may be implemented in at least one hardware form among a digital signal processor (DSP), a field programmable gate array (FPGA), and a programmable logic array (PLA). The processor 1001 may also include a main processor and a coprocessor. The main processor is a processor configured to process data in an awake state, and is also referred to as a central processing unit (CPU). The coprocessor is a low-power processor configured to process data in a standby state. In some embodiments, the processor 1001 may be integrated with a graphics processing unit (GPU). The GPU is configured to render and draw content that needs to be displayed on a display screen. In some embodiments, the processor 1001 may further include an artificial intelligence (AI) processor. The AI processor is configured to process computing operations related to machine learning.

The memory 1002 may include one or more computer-readable storage media. The computer-readable storage medium may be tangible and non-transient. The memory 1002 may further include a high-speed random access memory and a nonvolatile memory, for example, one or more disk storage devices or flash storage devices. In some embodiments, the non-transitory computer-readable storage medium in the memory 1002 is configured to store at least one instruction. The at least one instruction is configured for being executed by the processor 1001 to implement the virtual environment-based interaction method in embodiments of this application.

In some embodiments, the computer device 1000 may alternatively include a display screen 1005.

The display screen 1005 is configured to display a user interface (UI). The UI may include a graph, text, an icon, a video, and any combination thereof. When the display screen 1005 is a touch display screen, the display screen 1005 also has a capability to collect a touch signal on or above a surface of the display screen 1005. The touch signal may be inputted to the processor 1001 as a control signal for processing. In some embodiments, the display screen 1005 is configured to provide a virtual button and/or a virtual keyboard that are/is also referred to as a soft button and/or a soft keyboard. In some embodiments, there may be one display screen 1005 disposed on a front panel of the computer device 1000. In other embodiments, there may be at least two display screens 1005 disposed on different surfaces of the computer device 1000 respectively or in a folded design. In some embodiments, the display screen 1005 may be a flexible display screen, disposed on a curved surface or a folded surface of the computer device 1000. Even, the display screen 1005 may be further set in a non-rectangular irregular pattern, namely, a special-shaped screen. The display screen 1005 may be prepared by using a material like a liquid crystal display (LCD) or an organic light-emitting diode (OLED). For example, character information of a first virtual character corresponding to a first killed individual, the resurrected first virtual character, a scanning frame, a movable carrier, an information panel, a character restoration area, and the like are all displayed based on the display screen 1005.

A person skilled in the art may understand that the structure shown in FIG. 14 does not constitute a limitation on the computer device, and the computer device may include more or fewer components than those shown in the figure, or some merged components, or different component arrangements.

In an exemplary embodiment, an embodiment of this application further provides a chip. The chip includes a programmable logic circuit and/or program instructions. When running on the computer device, the chip is configured to implement the virtual environment-based interaction method provided in the foregoing method embodiments.

This application provides a non-volatile computer-readable storage medium. The non-volatile computer-readable storage medium has a computer program stored thereon, and the computer program is loaded and executed by a processor, to enable a computer to implement the virtual environment-based interaction method provided in the foregoing method embodiments.

An embodiment of this application provides a computer program product or a computer program. The computer program product or the computer program includes computer instructions. The computer instructions are stored on a non-volatile computer-readable storage medium. A processor of a computer device reads the computer instructions from the non-volatile computer-readable storage medium, and executes the computer instructions, to enable the processor of the computer device to load and execute the computer instructions to implement the virtual environment-based interaction method provided in the foregoing method embodiments.

A person of ordinary skill in the art may understand that all or some of the operations of the foregoing embodiments may be implemented by hardware, or may be implemented by a program instructing related hardware. The program may be stored in a computer-readable storage medium. The computer-readable storage medium may be a read-only memory, a magnetic disk, an optical disc, or the like.

A person skilled in the art may be aware that in the foregoing one or more examples, functions described in embodiments of this application may be implemented by using hardware, software, firmware, or any combination thereof. When implemented by using software, the functions can be stored in a computer-readable medium or can be used as one or more instructions or code in a computer-readable medium for transferring. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual environment-based interaction method performed by a computer device, the method comprising:
displaying at least one killed individual located in a virtual environment;
in response to a resurrection skill selection operation, displaying character information of a first virtual character corresponding to a first killed individual, the first killed individual being a killed individual selected through the resurrection skill selection operation from the at least one killed individual; and
switching display from the first killed individual to the resurrected first virtual character in response to a resurrection skill casting operation.

2. The method according to claim 1, wherein the displaying character information of the first virtual character corresponding to the first killed individual comprises:
displaying a scanning frame in response to the resurrection skill selection operation; and
displaying the character information of the first virtual character corresponding to the first killed individual selected by using the scanning frame.

3. The method according to claim 2, wherein the displaying the character information of the first virtual character corresponding to the first killed individual selected by using the scanning frame comprises:
displaying a movable carrier in response to the resurrection skill selection operation; and
displaying, in a peripheral area of the movable carrier, the character information of the first virtual character corresponding to the first killed individual selected by using the scanning frame,
a display position of the character information of the first virtual character moving with the movable carrier.

4. The method according to claim 3, wherein the displaying, in the peripheral area of the movable carrier, the character information of the first virtual character corresponding to the first killed individual selected by using the scanning frame comprises:
displaying an information panel in the peripheral area of the movable carrier; and
displaying, in the information panel, the character information of the first virtual character corresponding to the first killed individual selected by using the scanning frame,
a display position of the information panel moving with the movable carrier.

5. The method according to claim 1, wherein the method further comprises:
displaying a moved scanning frame in response to a move operation, the moved scanning frame being configured for selecting a second killed individual of the at least one killed individual; and
displaying character information of a second virtual character corresponding to the second killed individual selected by using the moved scanning frame.

6. The method according to claim 1, wherein the switching display from the first killed individual to the resurrected first virtual character in response to a resurrection skill casting operation comprises:
displaying a character restoration area in response to the resurrection skill casting operation, the character restoration area being configured for restoring a character model of the first virtual character corresponding to the first killed individual;
restoring, in the character restoration area, the character model of the first virtual character corresponding to the first killed individual; and
switching display from the first killed individual to the resurrected first virtual character in response to completion of character model restoration.

7. The method according to claim 6, wherein the displaying the character restoration area in response to the resurrection skill casting operation comprises:
playing back a casting animation of the movable carrier in response to the resurrection skill casting operation, the casting animation being configured for representing casting a resurrection skill to the first virtual character corresponding to the first killed individual; and
displaying the character restoration area in response to completion of casting animation playback.

8. The method according to claim 1, wherein the displaying character information of the first virtual character corresponding to the first killed individual comprises:
recommending the first killed individual from the at least one killed individual in response to the resurrection skill selection operation; and
displaying the character information of the first virtual character corresponding to the recommended first killed individual.

9. A computer device, comprising: a processor and a memory, the memory having a computer program stored therein, and the computer program, when loaded and executed by the processor, causing the computer device to implement a virtual environment-based interaction method including:
displaying at least one killed individual located in a virtual environment;
in response to a resurrection skill selection operation, displaying character information of a first virtual character corresponding to a first killed individual, the first killed individual being a killed individual selected through the resurrection skill selection operation from the at least one killed individual; and
switching display from the first killed individual to the resurrected first virtual character in response to a resurrection skill casting operation.

10. The computer device according to claim 9, wherein the displaying character information of the first virtual character corresponding to the first killed individual comprises:
displaying a scanning frame in response to the resurrection skill selection operation; and
displaying the character information of the first virtual character corresponding to the first killed individual selected by using the scanning frame.

11. The computer device according to claim 10, wherein the displaying the character information of the first virtual character corresponding to the first killed individual selected by using the scanning frame comprises:
displaying a movable carrier in response to the resurrection skill selection operation; and
displaying, in a peripheral area of the movable carrier, the character information of the first virtual character corresponding to the first killed individual selected by using the scanning frame,
a display position of the character information of the first virtual character moving with the movable carrier.

12. The computer device according to claim 11, wherein the displaying, in the peripheral area of the movable carrier, the character information of the first virtual character corresponding to the first killed individual selected by using the scanning frame comprises:
displaying an information panel in the peripheral area of the movable carrier; and
displaying, in the information panel, the character information of the first virtual character corresponding to the first killed individual selected by using the scanning frame,
a display position of the information panel moving with the movable carrier.

13. The computer device according to claim 9, wherein the method further comprises:
displaying a moved scanning frame in response to a move operation, the moved scanning frame being configured for selecting a second killed individual of the at least one killed individual; and
displaying character information of a second virtual character corresponding to the second killed individual selected by using the moved scanning frame.

14. The computer device according to claim 9, wherein the switching display from the first killed individual to the resurrected first virtual character in response to a resurrection skill casting operation comprises:
displaying a character restoration area in response to the resurrection skill casting operation, the character restoration area being configured for restoring a character model of the first virtual character corresponding to the first killed individual;
restoring, in the character restoration area, the character model of the first virtual character corresponding to the first killed individual; and
switching display from the first killed individual to the resurrected first virtual character in response to completion of character model restoration.

15. The computer device according to claim 14, wherein the displaying the character restoration area in response to the resurrection skill casting operation comprises:
playing back a casting animation of the movable carrier in response to the resurrection skill casting operation, the casting animation being configured for representing casting a resurrection skill to the first virtual character corresponding to the first killed individual; and
displaying the character restoration area in response to completion of casting animation playback.

16. The computer device according to claim 9, wherein the displaying character information of the first virtual character corresponding to the first killed individual comprises:
recommending the first killed individual from the at least one killed individual in response to the resurrection skill selection operation; and
displaying the character information of the first virtual character corresponding to the recommended first killed individual.

17. A non-transitory computer-readable storage medium, having a computer program stored thereon, the computer program, when loaded and executed by a processor of a computer device, causing the computer device to implement a virtual environment-based interaction method including:
displaying at least one killed individual located in a virtual environment;
in response to a resurrection skill selection operation, displaying character information of a first virtual character corresponding to a first killed individual, the first killed individual being a killed individual selected through the resurrection skill selection operation from the at least one killed individual; and
switching display from the first killed individual to the resurrected first virtual character in response to a resurrection skill casting operation.

18. The non-transitory computer-readable storage medium according to claim 17, wherein the displaying character information of the first virtual character corresponding to the first killed individual comprises:
displaying a scanning frame in response to the resurrection skill selection operation; and
displaying the character information of the first virtual character corresponding to the first killed individual selected by using the scanning frame.

19. The non-transitory computer-readable storage medium according to claim 17, wherein the method further comprises:
displaying a moved scanning frame in response to a move operation, the moved scanning frame being configured for selecting a second killed individual of the at least one killed individual; and
displaying character information of a second virtual character corresponding to the second killed individual selected by using the moved scanning frame.

20. The non-transitory computer-readable storage medium according to claim 17, wherein the switching display from the first killed individual to the resurrected first virtual character in response to a resurrection skill casting operation comprises:
displaying a character restoration area in response to the resurrection skill casting operation, the character restoration area being configured for restoring a character model of the first virtual character corresponding to the first killed individual;
restoring, in the character restoration area, the character model of the first virtual character corresponding to the first killed individual; and
switching display from the first killed individual to the resurrected first virtual character in response to completion of character model restoration.
